(19) United States
(12) Patent Application Publication
(10) Pub. No.: US 2022/0090304 A1
(43) Pub. Date: Mar. 24, 2022

(54) MOTOR VEHICLE FLOOR COVERING, BOOT OR TRUNK COVERING OR LOAD COMPARTMENT COVERING HAVING A STRUCTURALLY NEEDLE-PUNCHED CARPET SURFACE

(71) Applicant: ADLER PELZER HOLDING GMBH, Hagen (DE)

(72) Inventors: Frank FALK, Albstadt (DE); Volkmar SCHULZE, Schierling (DE); Matthias DICKERT, Witten (DE); Ray SINGH, Schwelm (DE)

(73) Assignee: ADLER PELZER HOLDING GMBH, Hagen (DE)

(21) Appl. No.: 17/423,451

(22) PCT Filed: Jan. 9, 2020
(86) PCT No.: PCT/EP2020/050386

§ 371 Date: Jul. 15, 2021

(30) Foreign Application Priority Data
Jan. 15, 2019 (DE) 102019100922.7

(51) Int. Cl. D04H 11/08; B32B 5/06; B32B 5/18; B32B 5/24; B32B 5/26

(52) U.S. Cl. CPC D04H 11/08; B32B 5/06; B32B 5/18; B32B 5/245; B32B 2605/00; B32B 2262/0284; B32B 2307/718; B32B 2471/02; B32B 5/26

(57) ABSTRACT

A subject matter of the invention is a three-dimensionally deformable velour carpet for a floor paneling, a luggage compartment paneling or a load floor paneling of a motor vehicle, which has a needled structure on the visible side produced by structured brushes in the brush belt.

The subject matter of the invention is a method of manufacturing a three-dimensionally shaped floor paneling, luggage compartment paneling or load floor paneling for motor vehicles, the carpet surface of which has a needled structure on the visible side, as well as the paneling themselves.

The surface material for a motor vehicle itself is a velour carpet, which may have several sub-layers as well as foam or fibre/nonwoven insulation towards the body.

Especially with the development of e-vehicles, design/styling is looking for alternative solutions in the deformable carpet surface, compared to plain, smooth flat needlepunch nonwoven, velour and tufted carpet.

In the case of motor vehicles with rear doors (station wagons) and fold-down rear seat backs, this styling also applies in particular to the luggage compartment and the load floor, since when the rear door is open and the rear seat backs are folded down, one looks from the rear into the interior of the motor vehicle which is thus released. Both the luggage compartment and the passenger compartment must then embody a uniform, coherent styling.

In the state of the art, various designs of carpet uppers for motor vehicle floor paneling, luggage compartment paneling and load floor paneling are known, namely in particular tufted, velour and flat needlepunched nonwoven carpets.

For tufted carpets, PA6.6, PA6, PP, rPA and PET, rPET as well as the corresponding biobased polyamides (PA 5.10; PA 6.10) are used in particular; and for the velour and flat needlepunched nonwoven carpets, PET, PET/PP, PP, PA/PET and rPET are mainly used as yarn/fibre material.

In the prior art, methods for the production of velour carpets are known, see among others DE 44 09 771 A1, DE 29 00 935 C2 and DE 10 2008 026 968 A1.

A nonwoven velour is a refined needlepunched nonwoven in which a fibre pile has been created in a prefabricated nonwoven material by means of needling in a running homogeneous brush belt. If this is then sheared to a defined pile height in a further process step, it is referred to as a sheared velour.

A velour carpet differs from a needlepunched nonwoven carpet in that it has a higher-quality look and feel, as well as improved wear behaviour.

For homogenisation of the stitch pattern in a needlepunched nonwoven, special processes are described in U.S. Pat. No. 9,567,698 B2, US 2016/0069006 A1, U.S. Pat. No. 9,260,806 B2, US 2015/0259836 A1 and EP 2 918 719 A1. In the production of a flat needle-punched nonwoven, staple fibres are consolidated after nonwoven formation by means of carding and crosslapping via multiple needling between two metal plates. In a further work step, by means of repeated needling in a brush belt, a velour needlepunched nonwoven can be produced from this flat needlepunched nonwoven. For both variants, it is necessary to thermally or chemically bond the staple fibres after needling to achieve good final strength.

The fibres are mostly incorporated by means of foamed latex or acrylate. A combined use of latex or acrylate and BiCo fibre (coPET/PET bicomponent fibre) is also common in practice. Furthermore, the integration is also realised exclusively via BiCo fibres.

WO 2017/061970 A1 specifically deals with the binding of the carpet using bicomponent (BiCo) fibres. Here, the optimisation of the (BiCo) fibre fixation by using special slot nozzles in the drying oven is described. In addition, the following are known: spread PE, EVA/PE mixture, extruded PE, films, hot glue, thermoplastic dispersions and thermobonding (EP 1 598 476 B1).

DE 2 008 439 C [U.S. Pat. No. 3,755,055] describes a method in which a monochrome or melanged nonwoven web and a nonwoven web printed on one side with pigment dyes with an ornamental pattern in one or more colours are laid on top of one another, wherein the printed side of one nonwoven web being turned away from the unprinted nonwoven web, and then both nonwoven webs are needled through from the unprinted surface to such an extent that the fibres of the unprinted nonwoven web mix with the fibres of the printed nonwoven web to form a pile on its printed surface and its printed ornamental pattern is changed to a soft and three-dimensional pattern.

DE 39 04 526 A1 discloses a floor covering and a method for its production. For the production of a floor covering consisting of two layers of needlepunched nonwoven, of which the top layer is structured on its upper side, the bottom layer is needled into the structured top layer from the underside thereof. The depth of the needling is much less than the thickness of the top layer. By needling the two layers together from the back of the top layer, the structure of this top layer is not destroyed. After needling, the two layers are additionally joined by impregnating them with a bonding agent through the top layer.

In EP 0 888 743 A1 [US 2002/0029445 A1, U.S. Pat. No. 6,287,407 B1, U.S. Pat. No. 6,398,895 B1], a structured textile material made of at least two different base nonwovens for the field of cleaning textiles is described. The technical teaching relates to a structured textile material made of at least two different needlepunched base nonwovens, wherein the base nonwovens have a structure obtained by needling from at least one side, wherein the needles used for structure needling are fork or crown needles and the depth of the forks or the beards, respectively, is selected such that they are completely filled with fibres of the base nonwoven facing the needles when the needles are pierced, and wherein the textile material has unmixed, pure fibres in the pattern, in the base and on the reverse side. In the method for producing the structured textile material, it is stated, on the one hand, that a lamination of the two needlepunched base nonwovens having melt fibres is carried out without activating the melt fibres, that a one-sided or two-sided structure needling is then carried out, and that the melt fibres of the base nonwovens are activated after the structure needling; and, on the other hand, in that, before entry into a structural needling machine, an intermediate layer of a material capable of bonding the two base nonwovens, in particular an adhesive nonwoven, is introduced between the two needled base nonwovens having melt fibres, in that the two base nonwovens and the intermediate layer are subjected to one-sided or two-sided structural needling, and in that the bond between the two base nonwovens and the intermediate layer is then produced by activating the melt fibres and the intermediate layer.

WO 2011/045691 A1 describes a graphic velour carpet and its production. Two structuring machines, each equipped with 2 needle boards, and a base and a top nonwoven are used. The base nonwoven is fed onto the top nonwoven between the two structuring machines and needled into a nonwoven in the second structuring machine. The needles in the needle boards are arranged according to predetermined patterns. An adhesive is applied to the base nonwoven, which then fixes/bonds the fibres of the nonwoven layers.

Furthermore, it is known to create patterns in a needlefelt web by means of several components, fibre layers and several needling processes, see among others DE 103 46 473 A1 and WO 2011/065851 A1.

DE 20 2009 000 775 U1 describes a fibre surface structure consisting of a needlepunched nonwoven or fibre pile (surface layer) on the visible side and a fibre pile or fibre nonwoven (pattern layer), which are joined together by needling by means of different needle types and/or needle arrangements and/or stitching directions and/or stitching depths.

The sample layer is pre-processed, the sample layer differs from the surface layer in the fibres themselves and the fibre colouring; also, the sample layer has been punched and/or cut out before needling with the surface layer; and is dyed and/or printed. Furthermore, several different sample piles or sample nonwovens are used as the sample layer. The surface layer is back-needled and surface-treated.

All “structure-needled” applications, methods and devices as well as material structures described in the prior art concern non-(single-layer) flat needlepunched nonwoven carpets for use in motor vehicles, their three-dimensional shaping into motor vehicle floor paneling, luggage compartment paneling or load floor paneling. Furthermore, there are no explanations for the structuring of velour surfaces by means of brush geometry and/or structuring of the brushes. There are no reports of a non-destructive structure that retains its surface structure in a durable manner during three-dimensional deformation in the contact heating field (laminating press), radiant heating field and in the deformation tool itself.

The object of the present invention in comparison with the aforementioned prior art is thus to provide a structurally needled carpet which is suitable for deformation and which upgrades the passenger compartment and/or luggage compartment and/or load compartment of motor vehicles to the effect that the latter has a “living room/well-being atmosphere”. In particular, it is an object of the invention, during the manufacture of velour carpet and/or the velourisation of needlepunched nonwoven carpet, to introduce a permanent, hard-wearing surface pattern with a possibly three-dimensional structure, which is structured differently over the width and length of the carpet surface and withstands three-dimensional deformation to form a motor vehicle floor or luggage compartment paneling.

In a first embodiment, the subject matter of the present invention is a method for producing a three-dimensionally deformable velour carpet for a floor paneling, a luggage compartment paneling or a load floor paneling of a motor vehicle with a structurally needled, deformation-resistant surface having a grammage of the carpet in the range from 180 g/m2 to 700 g/m2, which is characterized in that at a defined setting of the penetration depth, a structured velour carpet is produced from an initial nonwoven, wherein one uses a brush belt which has segmental or partial sections of different brushes and/or brush arrangements and provides and deforms this velour carpet with one or more sub-layers.

The core of the present invention is thus the provision of a velour carpet, produced in a conventional standard process, for the manufacture of a floor paneling, a luggage compartment paneling or a load floor paneling of a motor vehicle with a structurally needled, deformation-resistant visible surface solely by the arrangement of brushes of the brush belt with different brush/brush fibre height and brush/brush fibre structure when needling and/or velouring the floor paneling, the luggage compartment paneling or the load floor paneling of a motor vehicle.

The brush belt is equipped over the width and length with predefined brush/brush fibre heights and/or brush/brush fibre structures, as well as needle types and/or geometries, which thus create a predefined structure of the velour surface.

The advantage of the present invention is to provide a deformation-resistant/stable, structurally needled velour carpet for the production of motor vehicle floor and luggage compartment paneling or load floor paneling without an additional working step in its production compared to standard velour carpet production.

The method of the present invention can be implemented-without additional non-woven layers, needling stages, needling machines or needle boards-on “standard” machines solely by means of the brush/brush fibre heights and brush/brush fibre structures, the brush belt assembly over the width and length, and the needle geometry/needle type.

A further embodiment of the present invention consists in a three-dimensionally shaped velour carpet for a floor paneling, a luggage compartment paneling or a load floor paneling of a motor vehicle with a structurally needled, deformation-resistant surface with a grammage of the carpet in the range from 180 g/m2 to 700 g/m2, further comprising one or more sublayers, wherein the visible side of the carpet has an optionally three-dimensional structurally needled, hard-wearing surface.

The realisation should preferably take place on the one hand with a single-layer and on the other hand with a two-layer velour carpet. In the case of a two-layer design, additional colour effects with different structures can be needled in.

Example of Execution:

For the production of a deformation-resistant/stable, structure-needled floor paneling, a pre-nonwoven made of a fibre mix consisting of 80% commercially available 13 dtex fibres, fibre length 60 mm, PET fibre and 20% commercially available 6.7 dtex fibres, fibre length 64 mm, PET fibre was used as the initial nonwoven. The basis weight was 480 g/m2.

The needle boards were equipped with fork needles from Groz-Beckert as follows:

In throughput direction
1. Board Fork Needle 15×17×32×40×63.5 V G 9077
2. Board Fork Needle 15×17×32×40×63.5 D G 9077 DUR

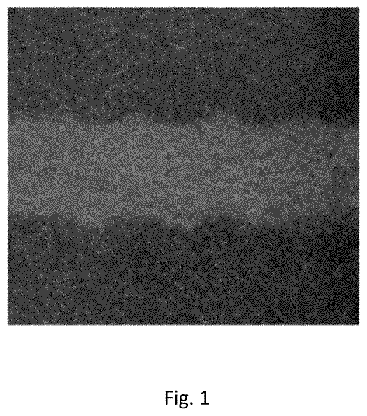

In the case of the velour carpet shown in FIG. 1, the penetration depth was 6 mm and the stitch density 550 stitches/cm².

The brushes of the brush belt had a 4.5 mm width and 2 mm depth, shortened height, transverse to the direction of travel.

The structure of the surface is clearly visible.

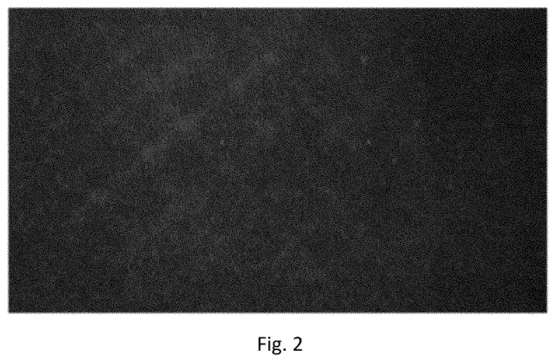

FIG. 2 shows a section of a velour carpet with a partially structure-needled diamond surface; the penetration depth here was 4 mm and the stitch density 550 stitches/cm2.

1. Method for the production of a three-dimensionally deformable velour carpet for a floor paneling, a luggage compartment paneling or a load floor paneling of a motor vehicle with a structurally needled, deformation-resistant surface with a grammage of the carpet in the range from 180 g/m2 to 700 g/m2, which is characterised in that at a defined setting of the penetration depth, a structured velour carpet is produced from an initial nonwoven, wherein one uses a brush belt which has segmental or partial sections of different brushes and/or brush arrangements and provides and deforms this velour carpet with one or more sub-layers.

2. Method according to claim 1, characterized in that,
the structuring of the bristles is carried out by arranging brush segments, by different brush heights and/or by defined placement and/or removal of bristles in the belt and/or dividing webs.

3. Three-dimensionally shaped velour carpet for a floor paneling, a luggage compartment paneling or a load floor paneling of a motor vehicle with a structurally needled, deformation-resistant surface with a grammage of the carpet in the range from 180 g/m2 to 700 g/m2, further comprising one or more sublayers, wherein the visible side of the carpet has an optionally three-dimensional structurally needled, hard-wearing surface.
